(19) United States
(12) Patent Application Publication
(10) Pub. No.: US 2017/0017708 A1
(43) Pub. Date: Jan. 19, 2017

(54) Entity-relationship modeling with provenance linking for enhancing visual navigation of datasets

(71) Applicant: Sqrrl Data, Inc., Cambridge, MA (US)

(72) Inventors: Adam P. Fuchs, Arlington, MA (US); Michael R. Allen, Lexington, MA (US); Michael A. Berman, Somerville, MA (US); Abiola D. Laniyonu, Somerville, MA (US); Jonathan J. Park, Cambridge, MA (US); Joseph P. Travaglini, Lynnfield, MA (US); John w. Vines, Cambridge, MA (US); Brien L. Wheeler, Newton, MA (US)

(21) Appl. No.: 14/801,950

(22) Filed: Jul. 17, 2015

(51) Int. Cl. G06F 17/30

(52) U.S. Cl. CPC G06F 17/30572; G06F 17/30604

(57) ABSTRACT

A method of data analysis is enabled by receiving raw data records extracted from one or more data sources, and then generating from the data records an entity-relationship model. The entity-relationship model comprises more entity instances, and one or more relationships between those entity instances. Data analysis of the model is facilitated using one or more provenance links. A provenance link associates raw data records and one or more entity instances. Using a visual explorer that displays a set of entity instances and relationships from a selected entity-relationship model, a user can display details for an entity instance, and see relationships between and among entity instances. By virtue of the underlying linkage provided by the provenance links, the user can also display source records for an entity instance, and display entity instances for a source record. The technique facilitates Big Data analytics.

### BACKGROUND

Technical Field

This application relates generally to tools and methods that enable analysis of data sets.

Brief Description of the Related Art

“Big Data” is the term used for a collection of data sets so large and complex that it becomes difficult to process (e.g., capture, store, search, transfer, analyze, visualize, etc.) using on-hand database management tools or traditional data processing applications. Such data sets, typically on the order of terabytes and petabytes, are generated by many different types of processes.

Big Data has received a great amount of attention over the last few years. Much of the promise of Big Data can be summarized by what is often referred to as the five V's: volume, variety, velocity, value and veracity. Volume refers to processing petabytes of data with low administrative overhead and complexity. Variety refers to leveraging flexible schemas to handle unstructured and semi-structured data in addition to structured data. Velocity refers to conducting real-time analytics and ingesting streaming data feeds in addition to batch processing. Value refers to using commodity hardware instead of expensive specialized appliances. Veracity refers to leveraging data from a variety of domains, some of which may have unknown provenance. Apache Hadoop™ is a widely-adopted Big Data solution that enables users to take advantage of these characteristics. The Apache Hadoop framework allows for the distributed processing of Big Data across clusters of computers using simple programming models. It is designed to scale up from single servers to thousands of machines, each offering local computation and storage. The Hadoop Distributed File System (HDFS) is a module within the larger Hadoop project and provides high-throughput access to application data. HDFS has become a mainstream solution for thousands of organizations that use it as a warehouse for very large amounts of unstructured and semi-structured data.

In 2008, when the National Security Agency (NSA) began searching for an operational data store that could meet its growing data challenges, it designed and built a database solution on top of HDFS that could address these needs. That solution, known as Accumulo, is a sorted, distributed key/value store largely based on Google's Bigtable design. In 2011, NSA open sourced Accumulo, and it became an Apache Foundation project in 2012. Apache Accumulo is within a category of databases referred to as NoSQL databases, which are distinguished by their flexible schemas that accommodate semi-structured and unstructured data. They are distributed to scale well horizontally, and they are not constrained by the data organization implicit in the SQL query language. Compared to other NoSQL databases, Apache Accumulo has several advantages. It provides fine-grained security controls, or the ability to tag data with security labels at an atomic cell level. This feature enables users to ingest data with diverse security requirements into a single platform. It also simplifies application development by pushing security down to the data-level. Accumulo has a proven ability to scale in a stable manner to tens of petabytes and thousands of nodes on a single instance of the software. It also provides a server-side mechanism (Iterators) that provides flexibility to conduct a wide variety of different types of analytical functions. Accumulo can easily adapt to a wide variety of different data types, use cases, and query types. While organizations are storing Big Data in HDFS, and while great strides have been made to make that data searchable, many of these organizations are still struggling to build secure, real-time applications on top of Big Data. Today, numerous Federal agencies and companies use Accumulo.

While technologies such as Accumulo provide scalable and reliable mechanisms for storing and querying Big Data, there remains a need to provide enhanced enterprise-based solutions that seamlessly but securely ingest and organize such data, and that make such data available for detailed analysis through easy-to-use tools and interfaces.

### BRIEF SUMMARY

This disclosure describes a method and system for analytics on data sets. To this end, a cloud-based computing infrastructure is enabled to ingest, secure, connect and analyze large amounts of data, whether structured, semi-structured or unstructured.

Preferably, data for analysis is organized within this infrastructure in a multi-tiered model. A first tier comprises the raw information that is to be analyzed, and this information may be captured from a number of different sources. On top of the raw data, a second tier comprises a linked data view extracting entities and relationships from the underlying data according to a configurable ontology. The linked data view is referred to herein as an “entity-relationship” model. The linked data, coupled with “provenance” links back to the underlying data sources, provides a mechanism to enable exploratory analysis of the data, preferably through a visual exploration, as well as automated anomaly detection, e.g., through machine learning and the like.

The above-described approach can be used to facilitate data analysis for many different types of use cases. Thus, for example, one use case might be a packet capture (PCAP) forensics analysis, in which case the raw logs might comprise information captured from a number of different sources, such as perimeter data, network data, and endpoint data. Upon receipt of an event (e.g., an alert), a query to an entity identified in the alert brings up a linked data view (based on an underlying entity-relationship model) that depicts visually how the entity in question is connected (relationship-wise) to one or more other entities. By drilling down into features (such as a time-series of activity) associated with an entity and then cross-referencing (as enabled by the provenance links) the underlying raw data, a detailed “rich” view of an entity and its behavior can then be identified. In particular, and by virtue of the provenance links, the user can move back and forth between an entity and the underlying raw data, seamlessly exploring the event in a contextual manner, typically as new or other entities and relationships get exposed in the displayed model. During the exploration, the user also can drill-down into a particular entry in the underlying raw data itself. Visual exploration of the data in this manner enables detection of an item of interest (e.g., a given node acting unexpectedly as a beacon, or a command and control server) relevant to the alert.

Generalizing, a method of data analysis is enabled by receiving raw data records extracted from one or more data sources in an enterprise, and then generating (from the received raw data records) an entity-relationship model. The entity-relationship model comprises more entity instances, and one or more relationships between those entity instances. To facilitate data analysis of the model, one or more provenance links are also generated and stored. These links may be generated as data is extracted from the raw data records. Generally, a provenance link according to this disclosure associates raw data records and one or more entity instances.

Advantageously, the provenance links enable visual exploration of the entity-relationship model to enable a user to identify an item of interest. These links include a provenance link of a first type, and a provenance link of a second type. The provenance link of the first type is a “back” (or “extracted from”) link that associates one or more raw data records for a given entity instance. The provenance link of the second type is a “forward” (or “contributed to”) link that associates an entity instance for a given raw data record. Preferably, the back links are stored in association with the raw data records, and the forward links are stored in association with the entity instances.

With this underlying data model, the entity-relationship model may be readily displayed and queried by a user, e.g., via a web-based dashboard. In a typical operation, the model is displayed as a graph, with each entity instance represented by a dot or node, with the relationship instances being represented by lines connecting the dots. In this approach, the user can query the entity-relationship model and, in response, the visual display may be updated. One update traverses the entity-relationship model to include a relationship that connects a new entity instance with an entity instance already visible in the entity-relationship model prior to receipt of the query.

As also noted, the nature of the underlying data analysis may vary and be of various types. As such, the infrastructure may be used to receive different types of enterprise data, and to build many different types of entity-relationship data models depending on the application analytics desired. Thus, in one embodiment, the raw data records comprise enterprise network security-related data sources including one of: syslog, netflow, PCAP, proxy logs and SIEM alerts, and the entities are cybersecurity actors and assets including one of: hosts, users, files and programs. A model populated with such data enables cybersecurity analysis (e.g., to identify a cybersecurity threat in the enterprise). In another embodiment, the raw data records comprise healthcare billing-related data sources, including health insurance claims filings, clinical records, prescription records, related enrichment sources, and the like, and the entities are actors and concepts such as doctors, patients, clinics, drugs, diagnoses, and the like, A model populated with such data enables healthcare analytics. Many other types of data and entity-relationship models may be implemented using the described paradigm and tooling.

The above use cases are merely representative. The data processing and visual (graph traversal) display methods herein may be used for any purpose wherein raw data records may be used to generate an entity-relationship model that is desired to be visually explored to identify an item of interest in the received raw data records.

The foregoing has outlined some of the more pertinent features of the subject matter. These features should be construed to be merely illustrative. Many other beneficial results can be attained by applying the disclosed subject matter in a different manner or by modifying the subject matter as will be described.

### BRIEF DESCRIPTION OF THE DRAWINGS

For a more complete understanding of the subject matter and the advantages thereof, reference is now made to the following descriptions taken in conjunction with the accompanying drawings, in which:

FIG. 1 depicts the technology architecture for an enterprise-based NoSQL database system according to this disclosure;

FIG. 2 depicts the architecture in FIG. 1 in an enterprise to provide identity and access management integration according to this disclosure;

FIG. 3 depicts a unified solution for integrating data to enable secure, real-time search, discovery and analytics according to this disclosure;

FIG. 4 depicts at a high level how the system organizes data upon ingest;

FIG. 5 depicts the data sources and modeling organization in more detail;

FIG. 6 depicts an example of a set of sources and models for a set of enterprise data to facilitate cybersecurity analytics, e.g., to identify a potential cybersecurity threat.

FIG. 7 depicts a preferred architecture in which a raw data store is used to maintain data sources (the raw event data), and a model store is used to maintain the entity-relationship model against which the analytics queries are executed;

FIG. 8 illustrates a representative data structure for the extracted from and connected to links of this disclosure;

FIG. 9 illustrates a representative entity-relationship model graph (a node-link diagram) that is generated by the system upon ingesting and organizing the enterprise data;

FIG. 10 depicts a representative details panel that is displayed upon a user action, e.g., selecting a particular entity node in the graph shown in FIG. 9;

FIG. 11 depicts the view the user clicks on the timeline visualization to drill down to a specific time frame;

FIG. 12 illustrates a pie-chart that is displayed in the details panel if the time series is also grouped;

FIG. 13 illustrates how the timeline for a grouping is displayed when the user clicks on a section of the pie chart in FIG. 12:

FIG. 14 illustrates a tooltips display showing the time and value for each point on the timeline that is rendered as the user hovers the mouse over the larger visualization;

FIG. 15 depicts an instance or relationship context menu by which the user can select a data source for which to display the source records;

FIG. 16 depicts the entity graph with the source records displayed in an underlying display panel;

FIG. 17 depicts how a user can perform a time-focused exploration from a time series through source data and back into the displayed node-link diagram;

FIG. 18 depicts how a user can launch a drill-down analysis into underlying data from a displayed relationship in the entity-relationship model;

FIG. 19 depicts the result of executing an outlier detection query against a particular node;

FIG. 20 depicts how a user can display additional information about a suspect outlier node; and

FIG. 21 depicts the outlier behavior against expected behavior for the peer group associated with the node shown in FIG. 20.

### DETAILED DESCRIPTION

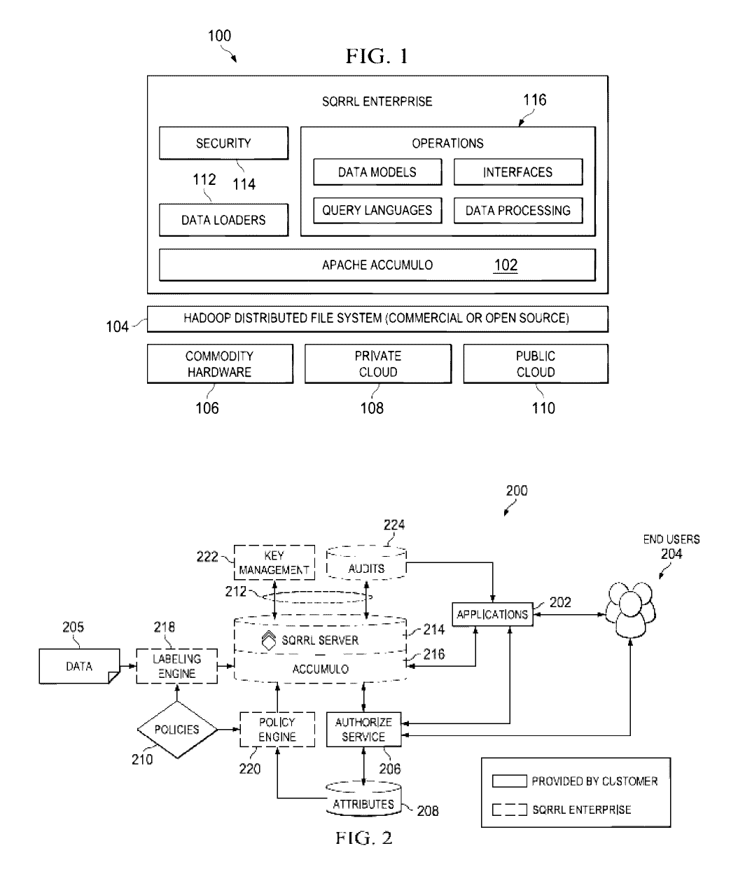

By way of background, the techniques of this disclosure may be implemented in a system such as described and illustrated in U.S. Pat. No. 8,914,323, the disclosure of which is incorporated herein by reference. FIG. 1 illustrates a technology architecture for this system. The system 100 comprises a set of components that sit on top of a NoSQL database, preferably Apache Accumulo 102. The system 100 (together with Accumulo) overlays a distributed file system 104, such as Hadoop Distributed File System (HDFS), which in turn executes in one or more distributed computing environments, illustrated by commodity hardware 106, private cloud 108 and public cloud 110. Sgrrl™ is a trademark of Sqrrl Data, Inc., the assignee of this application.

Generalizing, the bottom layer typically is implemented in a cloud-based architecture. As is well-known, cloud computing is a model of service delivery for enabling on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Available services models that may be leveraged in whole or in part include: Software as a Service (SaaS) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications). A cloud platform may comprise co-located hardware and software resources, or resources that are physically, logically, virtually and/or geographically distinct. Communication networks used to communicate to and from the platform services may be packet-based, non-packet based, and secure or non-secure, or some combination thereof.

Referring back to FIG. 1, the system components comprise a data loader component 112, a security component 114, and an analytics component 116. Generally, the data loader component 112 provides integration with a data ingest service, such as Apache Flume, to enable the system to ingest streaming data feeds, such as log files. The data loader 112 can also bulk load JSON, CSV, and other file formats. The security component 114 provides data-centric security at the cell-level (i.e., each individual key/value pair is tagged with a security level). As will be described in more detail below, the security component 114 provides a labeling engine that automates the tagging of key/value pairs with security labels, preferably using policy-based heuristics that are derived from an organization's existing information security policies, and that are loaded into the labeling engine to apply security labels at ingest time. The security component 114 also provides a policy engine that enables both role-based and attribute-based access controls. As will also be described, the policy engine in the security component 114 allows the organization to transform identity and environmental attributes into policy rules that dictate who can access certain types of data. The security component 114 also integrates with enterprise authentication and authorization systems, such as Active Directory, LDAP and the like. The analytics component 116 enables the organization to build a variety of analytical applications and to plug existing applications and tools into the system. The analytics component 116 preferably supports a variety of query languages (e.g., Lucene, custom SQL, and the like), as well as a variety of data models that enable the storage of data as key/value pairs (native Accumulo data format), as graph data, and as JavaScript Object Notation (JSON) data. The analytics component 116 also provides an application programming interface (API), e.g., through Apache Thrift. The component 116 also provides real-time processing capabilities powered by iterators (Accumulo's native server-side mechanism), and an extensible indexing framework that indexes data upon.

FIG. 2 depicts the architecture in FIG. 1 integrated in an enterprise environment. In this embodiment, it is assumed that the enterprise 200 provides one or more operational applications 202 to enterprise end users 204. An enterprise service 206 (e.g., Active Directory, LDAP, or the like) provides identity-based authentication and/or authorization in a known manner with respect to end user attributes 208 stored in attributed database. The enterprise has a set of information security policies 210. To provide identity and access management integration, the system 212 comprises server 214 and NoSQL database 216, labeling engine 218, and policy engine 220. The system may also include a key management module 222, and an audit sub-system 224 for logging. The NoSQL database 216, preferably Apache Accumulo, comprises an internal architecture (not shown) comprising tablets, tablet servers, and other mechanisms. The reader's familiarity with Apache Accumulo is presumed. As is well-known, tablets provide partitions of tables, where tables consist of collections of sorted key-value pairs. Tablet servers manage the tablets and, in particular, by receiving writes from clients, persisting writes to a write-ahead log, sorting new key-value pairs in memory, periodically flushing sorted key-value pairs to new files in HDFS, and responding to reads from clients. During a read, a tablet server provides a merge-sorted view of all keys and values from the files it created and the sorted in-memory store. The tablet mechanism in Accumulo simultaneously optimizes for low latency between random writes and sorted reads (real-time query support) and efficient use of disk-based storage. This optimization is accomplished through a mechanism in which data is first buffered and sorted in memory and later flushed and merged through a series of background compaction operations. Within each tablet a server-side programming framework (called the Iterator Framework) provides user-defined programs (Iterators) that are placed in different stages of the database pipeline, and that allow users to modify data as it flows through Accumulo. Iterators can be used to drive a number of real-time operations, such as filtering, counts and aggregations.

The Accumulo database provides a sorted, distributed key-value data store in which keys comprises a five (5)-tuple structure: row (controls atomicity), column family (controls locality), column qualifier (controls uniqueness), visibility label (controls access), and timestamp (controls versioning). Values associated with the keys can be text, numbers, images, video, or audio files. Visibility labels are generated by translating an organization's existing data security and information sharing policies into Boolean expressions over data attributes. In Accumulo, a key-value pair may have its own security label that is stored under the column visibility element of the key and that, when present, is used to determine whether a given user meets security requirements to read the value. This cell-level security approach enables data of various security levels to be stored within the same row and users of varying degrees of access to query the same table, while preserving data confidentiality. Typically, these labels consist of a set of user-defined labels that are required to read the value the label is associated with. The set of labels required can be specified using syntax that supports logical combinations and nesting. When clients attempt to read data, any security labels present in a cell are examined against a set of authorizations passed by the client code and vetted by the security framework. Interaction with Accumulo may take place through a query layer that is implemented via a Java API. A typical query layer is provided as a web service (e.g., using Apache Tomcat).

Referring back to FIG. 2, the labeling engine 218 automates the tagging of key-value pairs with security labels, e.g., using policy-based heuristics. These labeling heuristics preferably are derived from an organization's existing information security policies 210, and they are loaded into the labeling engine 218 to apply security labels, preferably at the time of ingest of the data 205. For example, a labeling heuristic could require that any piece of data in the format of “xxx-xx-xxxx” receive a specific type of security label (e.g., “ssn”). The policy engine 220 provides both role-based and attribute-based access controls. The policy engine 220 enables the enterprise to transform identity and environmental attributes into policy rules that dictate who can access certain types of data. For example, the policy engine could support a rule that data tagged with a certain data-centric label can only be accessed by current employees during the hours of 9-5 and who are located within the United States. Another rule could support a rule that only employees who work for HR and who have passed a sensitivity training class can access certain data. Of course, the nature and details of the rule(s) are not a limitation.

The process for applying these security labels to the data and connecting the labels to a user's designated authorizations is now described. The first step is gathering the organization's information security policies and dissecting them into data-centric and user-centric components. As data 205 is ingested, the labeling engine 218 tags individual key-value pairs with data-centric visibility labels that are preferably based on these policies. Data is then stored in the database 216, where it is available for real-time queries by the operational application(s) 202. End users 204 are authenticated and authorized to access underlying data based on their defined attributes. For example, as an end user 204 performs an operation (e.g., performs a search) via the application 202, the security label on each candidate key-value pair is checked against the set of one or more data-centric labels derived from the user-centric attributes 208, and only the data that he or she is authorized to see is returned.

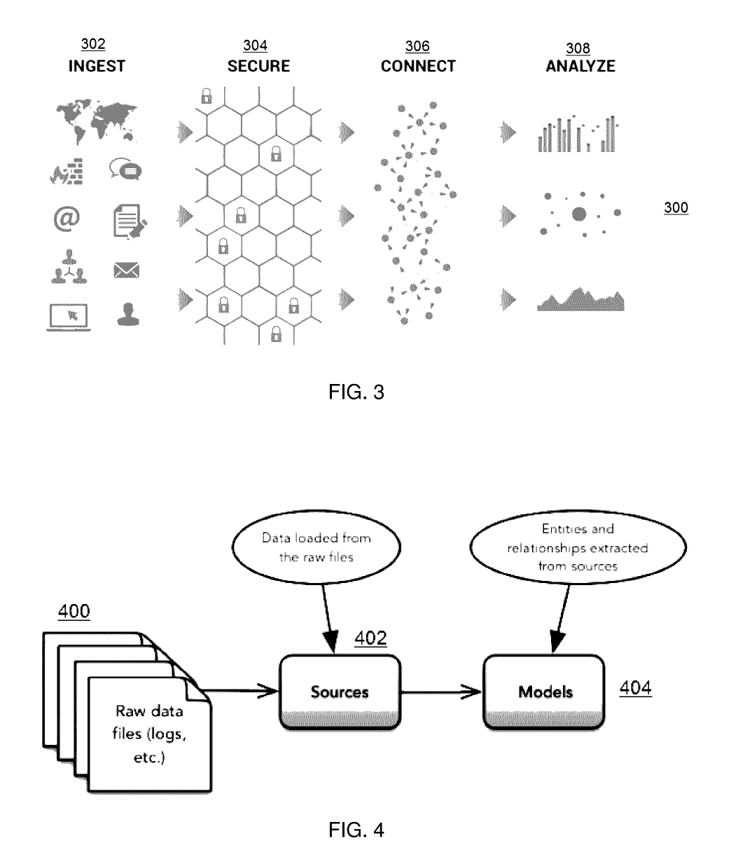

The above-described database system may comprise part of a unified solution for integrating data to enable secure, real-time search, discovery and analytics. FIG. 3 depicts the unified solution 300 in one embodiment. In particular, and using the platform as described above, organizations can ingest 302, secure 304, connect 306 and analyze 308 massive amounts of structured, semi-structured and unstructured data. As used herein, “ingest” 302 refers to the streaming or bulk data ingest from any source (e.g., using the data ingest service 214 in FIG. 2), and “secure” 304 refers to the encryption and labeling of data with fine-grained access controls (e.g., using the labeling engine 218 in FIG. 2). According to this disclosure, and as will be described below, to “connect” 306 refers to the ability of the system to automatically organize data and extract information, preferably with respect to “entities,” and “relationships” between and among those entities. Further, to “analyze” 308 refers to a capability (preferably enabled using web-based dashboarding) that enables visual, contextual-based navigation of the data and relationships in the system. By providing a unified solution (for ingesting, securing, connecting and analyzing large data sets), the system enables Big Data analytics in a variety of areas including, without limitation, cybersecurity analytics, healthcare analytics, intelligence analytics, and many others. Various use cases will be described in more detail below.

FIG. 4 depicts at a high level how the system organizes data upon ingest. The enterprise data typically comprises raw data 400, which is organized into sources 402, which are then used to populate one or more models 404. As will be described, models 404 comprise entities (collections of items gleaned from sources) and relationships (connections between entities).

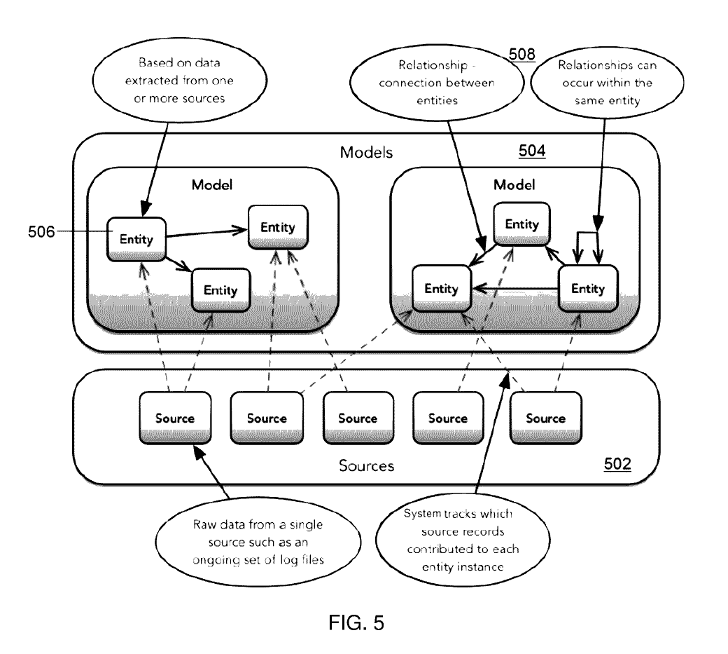

FIG. 5 depicts this organization in more detail. In this example, sources 502 contain the raw data 500 from external sources, e.g., log files. Source data can be updated regularly as new data is added to the original files. Sources 502 are used to create models 504. Each model comprises one or more entities 506, and one or more relationships 508. Generally, an entity is a set of data containing a collection of items, such as users, hosts, or email messages. Each instance of an entity 506 comprises one or more features describing that entity. The feature values may be gathered from data in multiple sources, and may include aggregated values. For example, for a “Hosts” entity, the feature could include IP addresses, hostname, location, and a total amount of data sent or received. Entities can be updated regularly to reflect new source data, and, as will be described in more detail below, the system also tracks which source records contributed to each instance of an entity. A relationship 508 generally reflects a connection between specific entities. For example, for a model containing host and user information, a relationship might consist of a user (username in a “Users” entity) logging into a host (destinationIP in a Hosts entity). In some cases, the relationship can be within the same entity. For example, for a Hosts entity, one host (sourceIP) may log into another host (destinationIP)

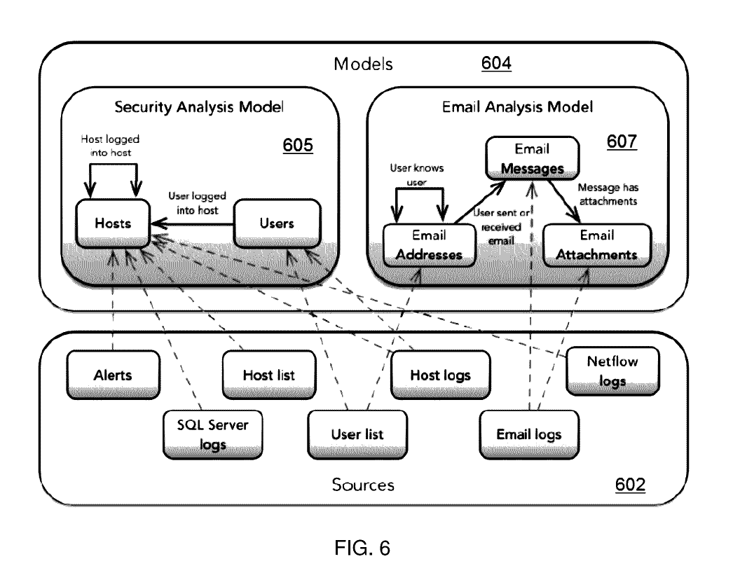

FIG. 6 depicts an example of a set of sources and models for a set of enterprise data. In this example, there are several sources 602, such as Host logs, a Hosts list, SQL Server logs, NetFlow logs, System alerts, Email logs, and a User list. From these sources, several models 604 are configured, namely, a security analysis model 605, and an email analysis model 607. The security analysis model contains several entities, namely Hosts (containing information based on most of the log files, the Host list, the User List, and the alerts list), and Users (containing information based on the User list and the Host logs). Within the security analysis model, Users and Hosts are connected by “User logged into Host” relationships, and Hosts are connected by “Host logged into host” relationships. The email analysis model 607 also contains several entities, namely, Email Addresses (based on information from the User list), Email Messages (based on information from the Email logs) Email Attachments (based on information from the Email logs). Within the email analysis model, Email addresses are connected by “User knows user” relationships. Email addresses and messages are connected by “Email address sent or received email” relationships.” Email messages and attachments are connected by “Email message contains attachment” relationships. Of course, the above are merely exemplary models, entities and relationships.

Typically, the raw enterprise data resides in and is distributed across HDFS, loaded into sources, and extracted to create models that include the entities and relationships between those entities. This latter function is the “connect” operation. Preferably, the “analysis” is enabled using a web application by which users explore the models to pinpoint activity and items of interest.

The “connect” and “analysis” functions are now described in further detail.

### Integrating Data to Enable Real-Time Search, Discovery and Analytics

With the above as background, the following provides more specific details regarding the “connect” and “analysis” modules. As used herein, the following terms have the following meanings:

A “graph” is a collection of entity and relationship instances that, typically, are depicted in a node-link diagram.

A “dataset” is a container for a set of co-located primitive datatypes, namely, documents and edges.

A “document” is a primitive datatype comprising a set of hierarchical keys with values, identified by a document uuid.

An “edge” is a primitive datatype connecting an origin and a destination document, with a label and single value.

“Raw data store” refers to a container for data that has been ingested from input data sources. It is composed of special purpose datasets containing raw data records.

A “raw data record” is a datatype comprising a collection of fields ingested for a single event, identified by the timestamp of that event. This corresponds to, for example, a single line from a log file.

A “record document UUID” is the document uuid that identifies the primitive document backing a single line from a log file.

A “model store” is a container for data that has been extracted via mappings out of the raw data store. The model store is composed of special purpose datasets containing entity and relationship instances.

An “entity instance” is a datatype comprising scalar, aggregate, and grouped features extracted from raw data records. Each entity instance is identified by its entity class and an instance identifier.

An “entity instance identifier” is a user-facing string, unique among all instances of a given entity class, that identifies a particular entity instance.

An “entity instance document uuid” is a document uuid that identifies the primitive document backing a single entity instance.

A “relationship instance” is a datatype representing a link between two entity instances. Each relationship instance is identified by its relationship class and its origin and destination entity instances. A relationship instance may contain a single value.

A “relationship edge label” is a label identifying the primitive edge backing a single relationship instance.

A “provenance link” is a data structure that enables discovering which raw data records contributed to a particular entity instance, or which entity instances were contributed to by a particular raw data record. A “provenance link” is sometimes referred to as a source link, an origin link, or the like.

A “back link” or “link back” is a type of provenance link that enables finding raw data records from an entity instance. Because these links are used in queries returning raw data records, they are preferably co-located in the raw data store. A “back” link is sometimes referred to as an “extracted from link.”

A “forward link” or “link forward” is a type of provenance link that enables finding entity instances from a raw data record. Because these links are used in queries returning entity instances, they are preferably co-located in the model store. A “forward” link is sometimes referred to as a “contributed to link.”

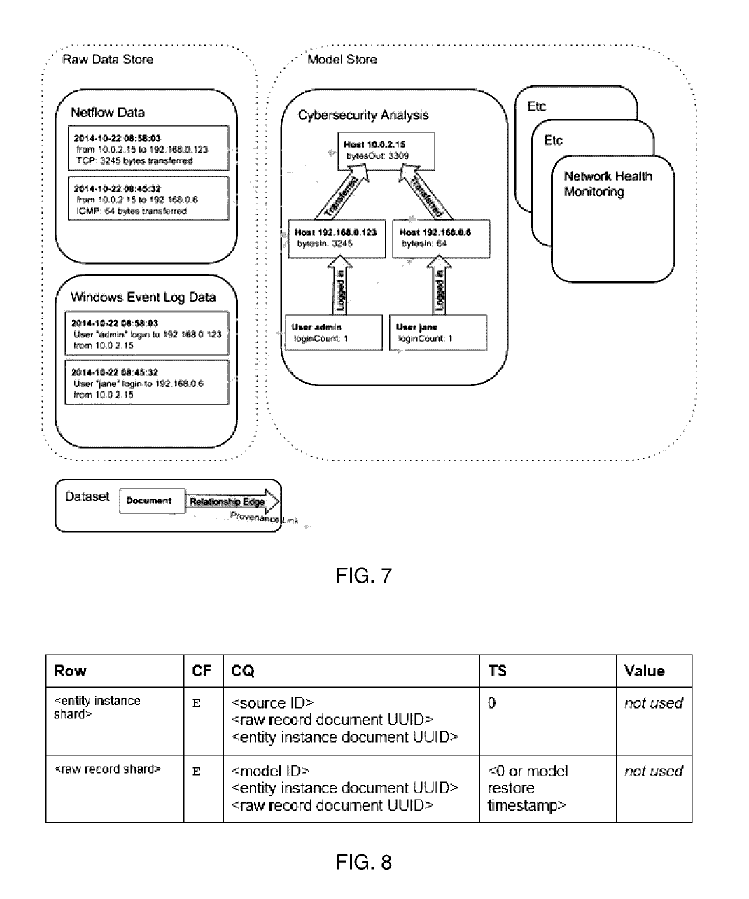

FIG. 7 depicts a representation raw data store 701, and an associated model store 703. Typically, the raw data store 701 comprises several sources 702, and the model store 703 comprises several models 704. In this example, the data sources 702 include NetFlow data, and Windows Event Log data, and the data model is a Cybersecurity Analysis model. Once again, these are merely exemplary. A dataset 706 is also depicted. The dataset 706, which is merely exemplary, includes a document 708, a relationship edge 710, and a provenance link 712.

In this approach, preferably both raw data records and entity instances are implemented on top of the primitive document datatype. Preferably, raw data record documents are partitioned into datasets by data source, and entity instances are partitioned into datasets by model. Preferably, relationships are implemented on top of the primitive edge datatype, and are stored in that model's dataset. As will be described, provenance links are implemented as a special datatype, similar to edges, but with some encoding and indexing differences to account for their unique access patterns and inter-dataset linkage. Preferably, provenance links are stored in the datasets with the objects they enable finding: back links for finding raw records in the raw data datasets, and forward links for finding entity and relationship instances in the model datasets.

Preferably, the enterprise data ingested from each data source goes into a unique raw data dataset, and the data extracted into each model also goes into a unique model dataset. Preferably, the datasets are identified by their Accumulo table ID, rather than by name. When a new data source definition or model is created (e.g., in a configuration data store), the corresponding dataset (with its backing table) is created automatically, and the table ID is used as the config object's UUID. The dataset/table name follows the data source or model name. Datasets backing data sources or models typically are manipulated (deletion, index configuration, etc.) through data source and model APIs.

Typically, the raw data records are derived from a single event, e.g., corresponding to one line in a log file. Preferably, each record has an event timestamp and a set of fields, and it is useful to remember which load job wrote each record and at what time. Event times are derived from the source data, and thus may not correspond to load time, come in sequential order, or be restricted to the past. For data sources whose records do not contain an explicit event time, the load time is used as the event time.

The following described anticipated access patterns with respect to the raw data store. These include write: ingest, delete: purge, read: extraction, read: queries, and read: finding provenance of entities or relationships. Each of these are now described in the following separate paragraphs.

The raw data store is written to during ingest, and each record is always new; fields written during ingest are never updated, however, users may annotate records in separate fields. The system may also provide streaming ingest into the raw data store as well, where each record is written by an individual API call.

Users will want to delete raw data records to age out old data and to excise erroneously ingested data. Typically, the aging out of old data is based on the record's event time, while removing bad data is done for all the data ingested by a particular load job.

The raw data store is read during an extraction process, and it can be interactively queried by users. For new data coming into the raw data store, extraction typically is run on all the data written by each ingest job run. For extracting model data from existing raw data, the extraction typically is run across all the data for an entire data source, or a range of event times across one or more (often all) data sources.

Users may construct arbitrary interactive queries against the raw data store, using query mechanisms such as described in U.S. Pat. No. 8,914,323, the disclosure of which is incorporated herein by reference. These include, without limitation, grouping, aggregation, and ordering. Typically, ranges of event times are used as a filter (e.g., “Find all records matching this query, where the event occurred in the past two weeks”). Queries may be against one or multiple data sources.

Provenance reads may work as follows. Given an entity instance (or set of instances), a user may want to find all of the raw data records whose fields contributed to that entity during extraction. A user may want to ask the same question for any individual entity feature. In one preferred embodiment, this is implemented by first finding all the records for an entity instance, then filtering out the specific feature contributors by reevaluating mappings. For scalar features, preferably the most recent record found is the contributor. For aggregate features, preferably all records found are contributors. The same question may be asked for a particular relationship instance. In this embodiment, preferably this operation is implemented by first finding the intersection of contributors to both incident entity instances, then by filtering by replaying. Preferably, provenance back links are written into the raw data store during model extraction, and they also may be read and written during model snapshot and restore, respectively. Provenance links are discussed in more detail in a dedicated section that follows below.

The following provides additional details regarding the raw data store.

The document UUID (the record primary identifier) determines the order of records stored in the dataset, so for raw data records, the form of the UUID is primarily motivated by the order the records should appear in. Because the purge, extraction of existing data, and interactive query operations typically are constrained to a range of event times, preferably records are stored sequentially by event time.

The fields in the primitive document underlying a raw data record preferably correspond directly to the fields of the record. The data source field names are used as the document field names. For hierarchical raw data records, for example coming from JSON data sources, document field paths are used in the natural way. Because the field path is used directly in the document and index entries, the field names for existing records cannot be changed.

The visibility labels of fields in the raw data store are configured essentially as for any load job: rules can be attached that may be per field or may depend on the data itself, and the field and corresponding index entries are labelled accordingly. The rules are configured as part of the data source configuration, and applied automatically at ingest time. Because raw data record fields are written exactly once, there is a single field at any given path for any given record.

Preferably, the full set of index options available to any dataset are available in the raw data store. These may include per-field and adjustable index options.

The raw data store may be structured to store data more efficiently via document field schemas. Preferably, the configuration necessary to create a schema is included in the data source configuration. Schemas for datasets backing the raw data store are managed automatically by the system based on the field definitions for the corresponding data source.

The following section provides additional details regarding a preferred implementation of the model store. As described above, entity and relationship instances are created and updated during the extraction process. Each entity instance belongs to a single entity class, preferably has a human-friendly identifier unique within that class, and has a set of features. Relationships link two entity instances, of the same or different classes, and contain a single value.

The anticipated access patterns with respect to the model store include write: extraction, write: annotation, read: queries, read: exploration, read: finding extraction targets of raw records, and snapshot and restore. Each of these are now described in the following paragraphs.

Preferably, entities and event-based relationships are written to by extraction jobs. As a job proceeds through raw data records, each record is examined and may make any number of contributions to any number of entities or relationships. Entity features are written with the value of a field expression from a raw data record. This is often a direct field-to-feature mapping, but may also, for example, be composed of multiple appended raw fields, or a raw field value rounded into a bucket covering a range of values. During this process, features may be updated many times; scalar features will be overwritten, and aggregate features will aggregate values across all updates. Aggregate features may be grouped by one or more scalar features. Event-based relationships are created via extraction from a single raw data record that identifies more than one entity instance. The value attached to the relationship may be mapped from fields of that record, as for entity features, but a relationship preferably contains only a single value. It may be scalar or aggregate, but typically it is not grouped or a structured object. Preferably, scalar feature and relationship values are overwritten if multiple raw data records contribute to the same feature. The effective, visible value of a feature then corresponds to the latest record that contributed to it, ordered by event time.

Write annotation may be enabled so that a user can notes or hand-crafted metadata to an entity or relationship instance. To this end, arbitrary fields may be added to an entity's document. Another approach is to have a dedicated “notes” field within each entity document that starts as an empty sub-document but fills out over time. The latter approach allows the system to namespace these annotations away from extracted features. As for relationships, because the edge label itself can only be single valued, a parallel set of annotation documents may be created for the annotated relationships.

Regarding read queries, users may construct arbitrary interactive tabular queries against the model store, using all of the query mechanisms available including, without limitation, grouping, aggregation, and ordering. Further details of a preferred user interface (UI) are described below. Generally, and as will be seen, users may construct arbitrary interactive graph queries against the model store, retrieving entity instances by feature, along with their relationships and neighboring nodes. Users may also find subgraphs of entity instances based on complex patterns that span relationships. Users may also find entity instances based on aggregates of grouped features within each entity instance. For example, if a feature is aggregated into buckets for each hour, a common query may be based on finding the value of that same feature re-aggregated across a whole day. Similarly, when retrieving entity instances, users may be interested in a specific range or subset of grouped features, or an aggregate thereof. Queries on features or graph structure may be restricted to finding results of a single entity class, or relationships among a small number of possible entity classes. Users may also query or view data based on the time of the event that contributed to that data. For example, when finding relationships, it may be common to only be interested in relationships that were asserted within some recent time window. Users may also retrieve a particular entity instance of interest directly, via a human-friendly identifier.

The web-based UI uses queries against the model store to enable exploration of the entity and relationship graph. As will be seen, common queries start from a small set of entity instances and retrieve entities or relationships of one or more classes in the neighborhood of the initial instances. When retrieving new entity instances, the UI is interested in any relationship that connects the newly retrieved entity instances with any already visible in the application. These exploration queries may be restricted to a single entity or relationship class, and they may additionally contain feature or event time filters.

Given a raw data record, a user may want to find all of the entity instances containing features or relationships that were extracted from that record. This functionality is enabled by the provenance links, and it is described in further detail below.

For the same reasons a user may want to purge the records ingested from a bad data source, a user may want to undo the contributions to a model from a bad extraction. Because it is difficult to untangle the result of multiple extractions on entity and relationship instances, the system provides the ability to snapshot the state of a model store and then restore that same state in the future. Following snapshot restoration, the model store is identical to its condition at the time the snapshot was taken, as if none of the intervening extractions occurred. This includes the provenance links related to this model that are hosted by the raw data store.

The following provides additional details regarding the model store.

The document UUID is required to update a field within that document, or to create an edge incident on that document, and using the UUID is the most efficient way to retrieve a single document; thus, for entities, preferably the form of the UUID is primarily motivated by the need to find the entity of interest during extraction and retrieval. Additionally, because queries are very often restricted to a single entity class, efficiently narrowing the search range of interest to a single class is an important consideration. Thus, the document UUID format for entity instances is:
<entity_class_id>_<instance_identifier>
   The instance identifier is typically a human-friendly string, for example a literal username or IP address. Because the instance identifier is used to determine which document to write extracted features into, each raw data record that contributes to an entity instance must be able to identify that instance. Each raw data record that contributes to a relationship must identify both the origin and destination instance. Typically, this means that some expression on the fields of the record must evaluate to the exact identifier for the instance. In the alternative, the system includes the capability to consult an external procedure for identifying instances given a raw data record.

Because features should be overwritten in event time order, and because many query use cases are dependent on the time of the event that contributed a feature or relationship, the event time of the raw record from which any feature or relationship is extracted is recorded. This information is recorded in the Accumulo key's timestamp for each document and index entry generated during an extraction. This allows the existing document field versioning process to enforce the overwriting behavior, and provides an options for filtering queries by event time early in the matching process.

The fields in the primitive document underlying each entity instance correspond to the features of that entity instance. The entity's feature names are used as the underlying field names. Grouped aggregate features are nested in objects according to their group. The root field has the name of the feature, and that object contains an entry for each group value. Multiply grouped features simply have additional levels of nesting. Because the feature name is used directly in the document and index entries, the names of features that have already been extracted are not changed.

Each relationship instance is represented by a single edge in the model's dataset. The origin and destination document UUIDs on the edge are the document UUID for the entity instances on either side of the relationship. The edge label is the relationship class's UUID, and the edge value is the relationship value. Because edges can have only a single value, relationships can have only a single value.

The visibility labels of entity instance features and relationships are inherited from the data source fields that contributed to them. Additionally, the visibility of any fields that contributed to identifying the entity instance must be included in the visibility labels of the resulting feature. Correspondingly, the visibility of a relationship must include that of any fields that contributed to identifying either endpoint, along with fields that contributed to the value. Different records may contribute to the same features, but with different visibility labels. For aggregate features, they are combined at read time, including only the components visible to the requesting user. For scalar features, preferably all features visible to the requesting user are retrieved, each annotated with its visibility label.

For the model store, a desirable set of indexes is chosen, e.g., fielded value indexes, an aggregate index, or the like. The system may also provide for per-feature or per-entity indexing configurations.

In one embodiment, indexing options and schema definitions are configured based on dataset and field path. Because all entity classes for a given model are in the same dataset, and feature names (and thus field names) may be reused among different entity classes, typically individual indexing options per entity or feature are not applied. Likewise, because feature names reused among entities may have different types, schemas are not applied to entity instance documents. In an alternative embodiment, each entity class has its own dataset, or entity class is supported in the configuration of indexes and schemas. Incorporating the entity class into the index and schema configuration requires creating a substructure within a dataset and building awareness of that structure into ingest and query pipelines.

The following provides additional details regarding the provenance linking functionality of this disclosure. As described above, the system advantageously enables a user to pivot from an entity or relationship instance, or set thereof, to the raw data records that they were extracted from. Similarly, a user is able to pivot from a raw data record (or records) to the entities and relationships that were extracted from it. Provenance links enable this type of exploration. These data structures are similar to edges, but with important modifications because they link across datasets and have unique, but more restricted, requirements around access patterns.

The anticipated access patterns for provenance links include write: extraction, read: pivot back, read: pivot forward, and model checkpoint and restore. Each of these are now described in the following paragraphs.

Provenance links are written during the extraction process. As the extraction progresses through each raw data record, a link is created for each entity instance contributed to by mappings from that record. For each event-based relationship contributed to, a link is created from the record to each of the two entity instances on either side of the relationship.

Given an entity instance (or set of instances), a user may want find all of the raw data records whose fields contributed to that entity during extraction. A user may ask the same question for any individual entity feature, or for one or more relationship instances.

Given a raw data record, a user may find all of the entity instances containing features or relationships that were extracted from that record.

When a model is restored from a snapshot, the state of all provenance links leading to entities in that model preferably is identical to that of the time of the snapshot.

The following provides additional details regarding the provenance link functionality.

For any query that retrieves documents from a data store according to some indexed filter, to maintain performance at scale, the index entries for a given document preferably are on the same shard as the document itself. This implies that the index that enables pivoting back to raw data records preferably is on the shard with the raw data records, and the index that enables pivoting forward to the model is on the same shard as the entity instances.

Maintaining explicit provenance links for individual features and relationships may be costly in terms of disk footprint and extraction time. The system, however, enables the user to examine provenance of features and relationships through a combination of using the entity links, and reevaluating mapping expressions.

As noted above, provenance links look like edges, but they differ in material respects. In particular, the “remote” side must identify the dataset that it points to, in addition to the document UUID. Additionally, given their expected access patterns, a locally-sorted index for provenance links is not necessary. Rather, a locally-sorted edge index may be used for unsourced edge queries and retrieval of all edges incident to the nodes found in a query. Because link queries are always based on a known source node, and the links themselves are never needed in a result set, maintaining a remote-sorted index is sufficient. In an alternative embodiment, a locally-sorted link index may be maintained and used for finding the provenance of a very large number of entities. Because provenance links are queried independently of regular edges, and they have only a subset of the usual edge indices, preferably they are assigned their own column family. In one illustrative embodiment, each provenance link comprises a pair of Accumulo entries such as shown in FIG. 8.

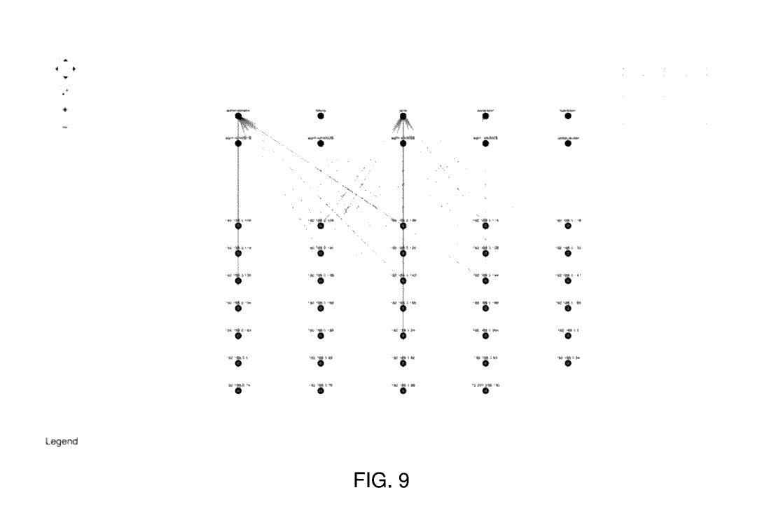

The following describes how the above-described mechanisms facilitate visual, contextual navigation of the data and relationships. Typically, a user opens up a browser or other mobile device-based rendering app to the system. Interactions typically occur over a network, e.g., using a web-based communication paradigm. To this end, the system application provides a web-based dashboard (a visual palette) on which a graph (the node-link diagram) is displayed. On the graph, each entity instance is represented by a dot, and the relationship instances are represented by lines connecting those dots. FIG. 9 illustrates a portion of one such graph. Preferably, the instances are color-coded to indicate the entity or relationship to which they below. The size of a node may reflect a characteristic of the data represented by the node (e.g., the amount of data sourced or sinked from the node). The relationship typically reflects a characteristic and/or direction of the relevant data flow between a pair of entities. The user navigates around the graph using standard tools, e.g., to move up, down, left or right, to zoom-in or out, to pan around, or to change the graph layout. As the user navigates around the graph, different portions of the graph may come into view or become hidden. Using a mouse or other control element, the user can select entity instances manually (e.g., by shift-clicking to select a set of individual instances, or by dragging the mouse to highlight a group of instances), or, using a pull-down context menu, by type or neighborhood. Alternatively, the user may create a selection filter to select entity instances, and a filter may be based on combinations of feature values, relationship values, content of MATCH query WHERE clauses, or the like.

The display of the graph can be changed readily. The user can drop and drag entity instances, arrange selected entity instances, and configure the display of items on the graph (e.g., hiding and displaying entity instance labels, using feature values to set the relative size of entity instances, change the relative width of relationship instances based on the relationship value, and the like).

The scope of the graph can be changed readily. For example, the user can use a MATCH query to display different data on the graph. Or, the user can expand the displayed entity instances, hide entity instances, create filter conditions to narrow the graph results, and the like.

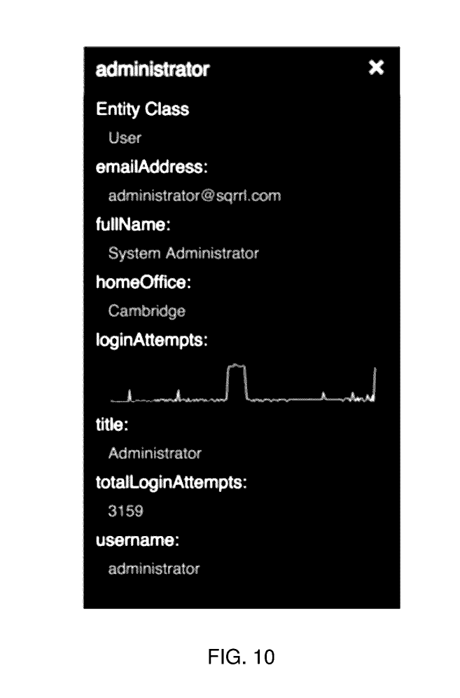

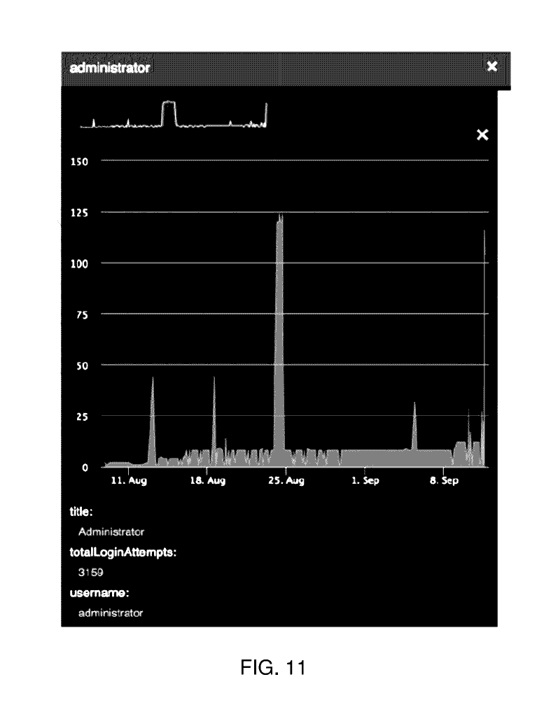

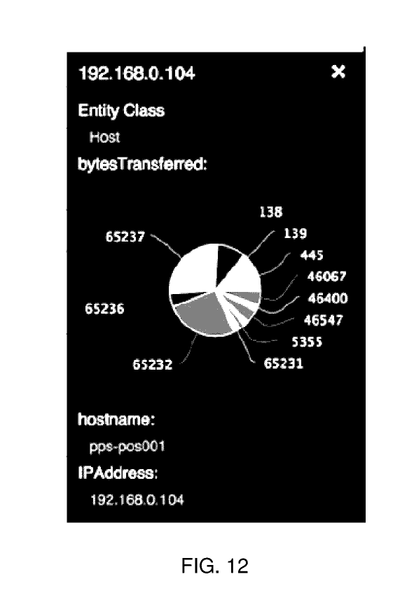

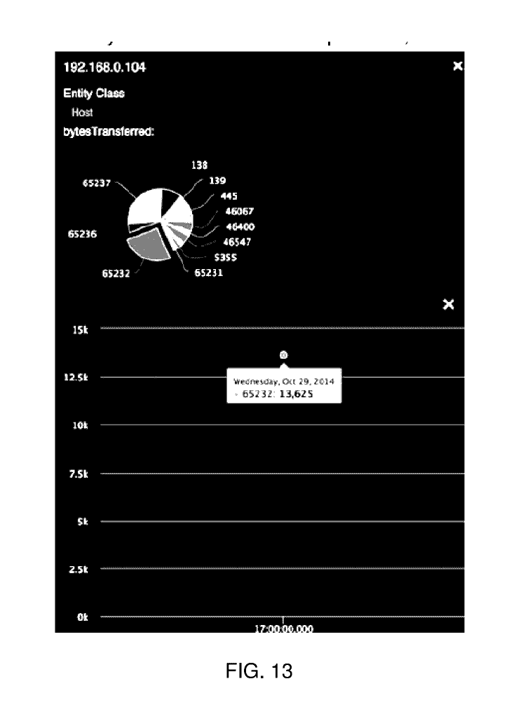

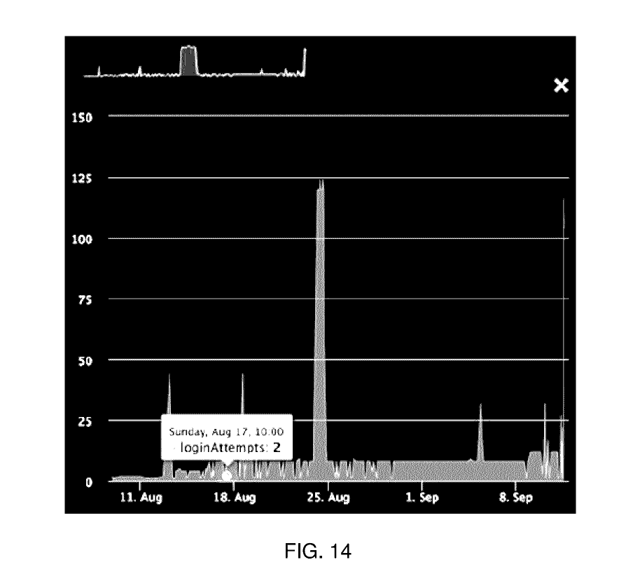

The details of the graph items displayed also may be varied. To this end, preferably the user interface (UI) exposes a details panel that may be selected for an entity instance. A representative details panel is shown in FIG. 10. The details panel is enabled under the covers by the provenance linking functionality, as explained by the following example. The details panel preferably includes the entity to which the instance belongs, and the values of the entity features for the instance. For basic grouped features, the details panel initially displays the feature values collapsed under the feature name. The user can expand and collapse the set of grouped valued. If a time series is not grouped, the details panel preferably displays a timeline of the time series values. The user can click on the timeline visualization to drill down to a specific time frame, such as shown in FIG. 11. If the time series is also grouped, then the details panel preferably display a pie-chart (or similar) showing the percentage of values for each grouping value. This is shown in FIG. 12. When the user clicks on a section of the pie chart, the timeline for that grouping value is displayed. This is shown in FIG. 13. As the user hovers the mouse over the larger visualization, tooltips display showing the time and value for each point on the timeline. This is shown in FIG. 14. Then, to display the source records for a specific point, all the user has to do is click the point. When the user clicks a specific point on the visualization, preferably the source records for that point are displayed. The ability of the system to obtain and display the source records leverages the underlying provenance linking functionality.

The details panel described above is merely representative, as the nature and scope of the information display of course will vary depending on the enterprise data, and the Big Data application that is examining that data.

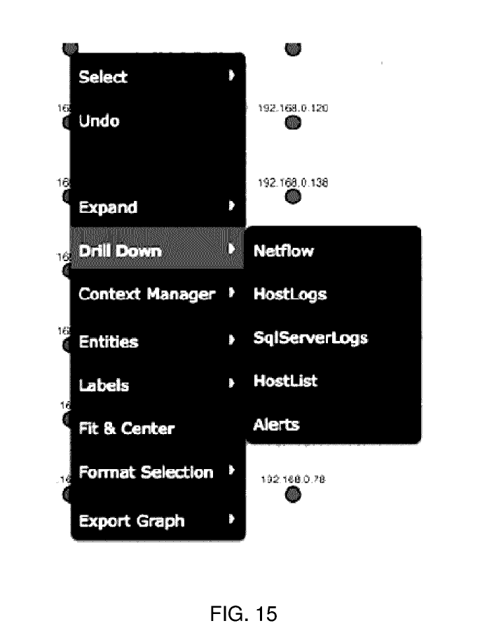

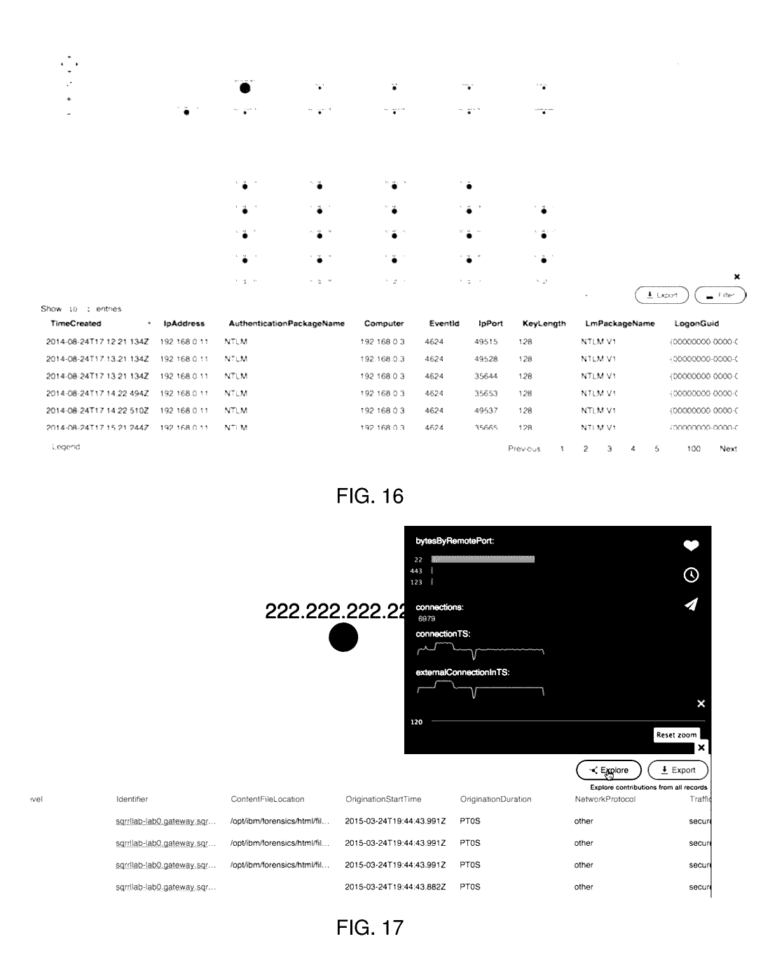

The following describes an additional UI tool that may be manipulated by the user to display source records that contributed to an entity or relationship instance (as evidenced by the underlying provenance links). As noted above, each entity or relationship instance can be generated from data in multiple records from multiple sources. To display a set of contributing source records for an entity or relationship instance, the user simply selects an instance or relationship context menu and selects to Drill Down. This is illustrated in FIG. 15 for a given model. The Drill Down menu preferably lists the sources that contributed to the entity or relationship instance. From the Drill Down menu, the user can select the source for which to display the source records. As illustrated in FIG. 16, the records are then displayed, preferably in a panel at the bottom of the page. As illustrated in FIG. 17, the user can zoom into a particular area of the node-link diagram, review a details panel for a given node, view data records that contributed to the entity or relationship instance, and even explore contributions from the underlying data records themselves. This enables the user to undertake a time-focused exploration from the time series through source data and back into the node-link diagram.

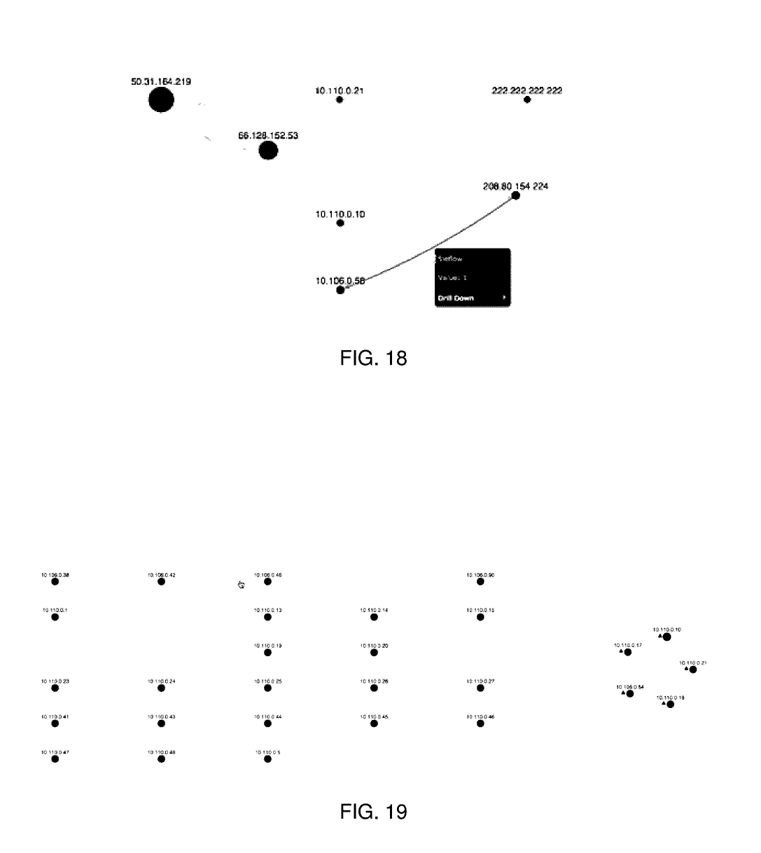

The drill-down capability may also be initiated from a relationship in the node-link diagram. Thus, and as shown in FIG. 18, there is a drill-down that pivots, starting from a relationship, to enable drill-down to a raw source (metadata) record. As noted above in FIG. 17, the user can then link directly to the contents of an actual data transfer that is a component of the relationship.

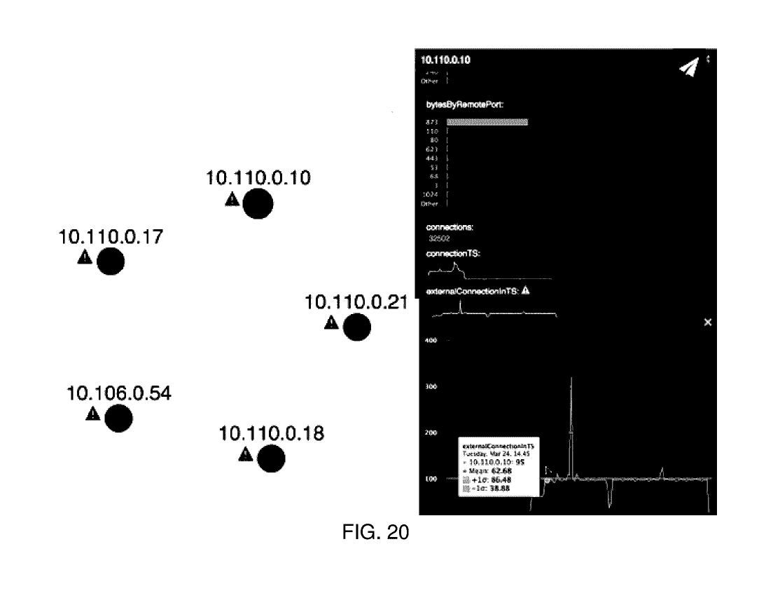

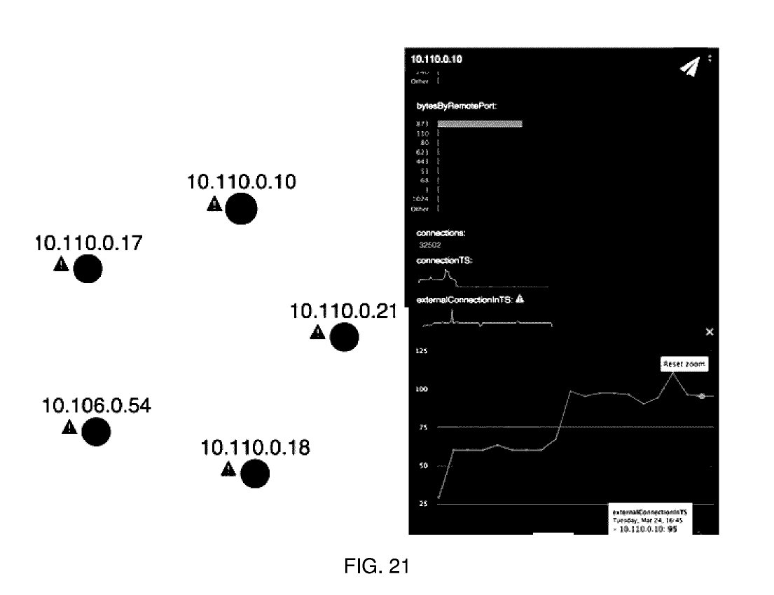

FIGS. 19-21 depict another feature of this disclosure. By organizing the enterprise data in the manner described, the system provides a robust way to analyze the behavior of a given entity with respect to a peer group of entities. One such analytic is entity peer group “outlier” detection. Continuing with the PCAP forensics analysis example scenario, and using the interface, the user or the system may identify a particular feature of interest (e.g., nodes that appear to be acting as beacons, nodes that appear to be acting as command and control servers, and the like). One way to identify this information is for the interface to display a dashboard that identifies potential anomalies that are to be further analyzed. The user can then select one of the nodes in the list and execute an outlier detection query. FIG. 19 depicts the result of executing such a query for a particular node. In this example, there are set of peer nodes 1900 displayed, together with a subset 1902 of the peer group that are outliers with respect to the feature of interest (e.g. time-series buckets exceeding an established baseline). As depicted in FIG. 20, the user can then select one of the outlier nodes and bring up a display panel with further relevant details for exploration. FIG. 21 illustrates the user zooming in on the timeline. Here, the outlier behavior (line 2100) is presented visually with respect to the expected behavior 2102 (illustrating a particular mean and standard deviation). The node is characterized as an outlier in this example because the behavior exceeded the expected behavior (based on the peer group) for a significant period of time (which is configurable). The expected behavior of the peer group may be generated from a machine learning method or algorithm, such as a statistical analysis. The entity peer group outlier detection that identifies a set of peers with a query, builds a statistical (or other machine-learning-based) model of the feature, and then identifies one or more entities of the peer group that are outliers with respect to the feature, is just one example of an entity-behavioral analytic that may be implemented by the platform. The particular ML technique that is used to determine the outlier behavior may be varied and configurable by the user or the system. Thus, for example, activity that is more than a given number of standard deviations from the mean may be characterized as outlier behavior.

Thus, according to this disclosure, a method of data analysis is enabled by receiving raw data records extracted from one or more data sources, and then generating from the received raw data records an entity-relationship model. The entity-relationship model comprises more entity instances, and one or more relationships between those entity instances. To facilitate data analysis of the model, one or more provenance links are also generated and stored. These links may be generated as data is extracted from the raw data records. Generally, a provenance link according to this disclosure associates raw data records and one or more entity instances. As described above and illustrated in the drawings, the provenance links enable visual exploration of the entity-relationship model to enable a user to identify an item of interest in the received raw data records. The provenance links include a provenance link of a first type, and a provenance link of a second type. The provenance link of the first type is a back link that associates one or more raw data records for a given entity instance. The provenance link of the second type is a forward link that associates an entity instance for a given raw data record. Preferably, the back links are stored in association with the raw data records, and the forward links are stored in association with the entity instances.

With this underlying data model, the entity-relationship model may be readily displayed and queried. In a typical operation, the model is displayed as a graph, with each entity instance represented by a dot or node, with the relationship instances being represented by lines connecting the dots. In this approach, the user can query the entity-relationship model and, in response, the visual display may be updated. One update traverses the entity-relationship model to include a relationship that connects a new entity instance with an entity instance already visible in the entity-relationship model prior to receipt of the query. While the provenance links facilitate the visual exploration of the entity-relationship model by enabling the user to locate and view items of interest, preferably the links are internal data structures that are not exposed during the visual exploration itself.

The nature of the underlying data analysis may vary and be of various types. Of course, the nature and type of enterprise data used to populate the model will vary accordingly. Thus, in one embodiment, the raw data records comprise enterprise network security-related data sources including one of: syslog, netflow, PCAP, proxy logs and SIEM alerts, and the entities are cybersecurity actors and assets including one of: hosts, users, files and programs. A model populated with such data enables cybersecurity analysis (e.g., to identify a cybersecurity threat in the enterprise). In another embodiment, the raw data records comprise healthcare billing-related data sources, including health insurance claims filings, clinical records, prescription records, related enrichment sources, and the like, and the entities are actors and concepts such as doctors, patients, clinics, drugs, diagnoses, and the like. A model populated with such data enables healthcare analytics. In yet another embodiment, the raw data records comprise financial training-related data sources, such as trade offer logs (puts, calls, etc.), trade execution logs, order management system logs, price quotes, communication records (email, chat, etc.), and the entities are actors and assets such as traders, securities, trading institutions, accounts, servers, and the like. A model populated with such data enables asset trading analytics. Still another embodiment may involves raw data records comprising intelligence analysis data sources, such as communications records, social relationship records, financial ownership records, associated enrichment, and the like, and the entities are actors and assets such as people, geographical regions, governments, organizations, companies, computers, communications devices, weapons, weapon components, ships, aircraft, and the like. A model populated with such data enables intelligence-related analytics. As another example use case, the raw data records comprise counter-party risk analysis data sources, such as credit records, historical account balances, investment records, reputation records, transaction records, employment records, and the like, and the entities are risk-related actors and assets, including people, accounts, securities, collateral objects, geographical locations, companies, and the like. A model populated with such data enables financial risk analytics.

The above use cases are merely representative. The data processing and visual display methods herein may be used for any purpose wherein raw data records may be used to generate an entity-relationship model that is desired to be visually-explored to identify an item of interest in the received raw data records.

As explained above, the item of interest may itself be outlier data that the system can detect by using ancillary or supplemental support tools. Thus, for example, the outlier data may be detected by applying a machine learning algorithm to a feature of the received raw data records. In this example scenario, and as shown in FIGS. 19-21, the machine learning algorithm includes a time-series analysis on one or more features associated with an entity instance. When visually-exploring the entity-relationship model for outlier data, the UI may also expose its own outlier button that can be selected by the user; upon such selection, the system updates the visual display to render the outlier data, and then the user can drill down to the underlying raw data as enabled by the provenance linking functionality previously described. The display of the entity-relationship model can then be re-organized in association with or around the outlier data. In this example, the outlier data itself represents a particular threat or anomaly.

As noted above, preferably the cloud services provider exposes a web-based application front-end to provide the visual explorer that displays a set of entity instances and relationships from a selected entity-relationship model. The visual explorer is enabled under the covers by the provenance linking. Using the tool (e.g., the details panel), the user can display details for an entity instance, and see relationships between and among entity instances. By virtue of the underlying linkage provided by the extracted from or contributed to links, the user can also display source records for an entity instance, and display entity instances for a source record.

While the preferred implementation of the visual explorer is as a web-based front-end (e.g., to a cloud infrastructure), the explorer may be implemented in a standalone manner. Thus, one or more of the four functions (ingest, secure, connect and analysis) may be carried out in the enterprise itself. One or more of these functions may be combined with one another. Each function may be implemented by one or more co-located or disparate machines, devices, programs, processes, applications, utilities, tooling and data.

The above-described architecture may be applied in many different types of use cases. General (non-industry specific) use cases include making Hadoop real-time, and supporting interactive Big Data applications. Other types of real-time applications that may use this architecture include, without limitation, cybersecurity applications, healthcare applications, smart grid applications, and many others.

As also noted, the approach herein is not limited to use with Accumulo; the security extensions (role-based and attribute-based access controls derived from information policy) may be integrated with other NoSQL database platforms. NoSQL databases store information that is keyed, potentially hierarchically. The techniques herein are useful with any NoSQL databases that also store labels with the data and provide access controls that check those labels.

Each above-described process preferably is implemented in computer software as a set of program instructions executable in one or more processors, as a special-purpose machine.

Representative machines on which the subject matter herein is provided may be Intel Pentium-based computers running a Linux or Linux-variant operating system and one or more applications to carry out the described functionality. One or more of the processes described above are implemented as computer programs, namely, as a set of computer instructions, for performing the functionality described.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject matter also relates to apparatus for performing the operations herein. This apparatus may be a particular machine that is specially constructed for the required purposes, or it may comprise a computer otherwise selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus. The functionality may be built into the name server code, or it may be executed as an adjunct to that code. A machine implementing the techniques herein comprises a processor, computer memory holding instructions that are executed by the processor to perform the above-described methods.

While given components of the system have been described separately, one of ordinary skill will appreciate that some of the functions may be combined or shared in given instructions, program sequences, code portions, and the like.

Preferably, the functionality is implemented in an application layer solution, although this is not a limitation, as portions of the identified functions may be built into an operating system or the like.

The functionality may be implemented with any application layer protocols, or any other protocol having similar operating characteristics.

There is no limitation on the type of computing entity that may implement the client-side or server-side of the connection. Any computing entity (system, machine, device, program, process, utility, or the like) may act as the client or the server.

While given components of the system have been described separately, one of ordinary skill will appreciate that some of the functions may be combined or shared in given instructions, program sequences, code portions, and the like. Any application or functionality described herein may be implemented as native code, by providing hooks into another application, by facilitating use of the mechanism as a plug-in, by linking to the mechanism, and the like.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, that provide the functionality of a given system or subsystem. As described, the functionality may be implemented in a standalone machine, or across a distributed set of machines.

The platform functionality may be co-located or various parts/components may be separately and run as distinct functions, in one or more locations (over a distributed network).

The techniques herein generally provide for the above-described improvements to a technology or technical field (namely, data analytics), as well as the specific technological improvements to other industrial/technological processes (e.g., cybersecurity applications, healthcare applications, smart grid applications, interactive Big Data applications, and many others) that use information storage and retrieval mechanisms, such as described above.

What is claimed is as follows:

1. A method of data analysis, comprising
receiving raw data source records extracted from one or more data sources;
generating from the received raw data source records at least one entity-relationship model, the entity-relationship model comprising one or more entity instances, and one or more relationships between those entity instances;
generating entity-to-source record index entries that relate entity instances with the source records that contribute to those entity instances;
combining the entity-to-source record index entries into an entity-to-source record index and co-locating the entity-to-source record index in a first data store that stores the source records;
generating source record-to-entity index entries that relate source records to the entity instances to which the source records contribute;
combining the source record-to-entity index entries into a source record-to-entity index and co-locating the source record-to-entity index in second data store that stores the entity instances and relationships, the second data store being distinct from the first data store;
identifying and displaying a set of one or more source records of interest during visual exploration of the entity-relationship model using the entity-to-source record index; and
identifying and displaying a set of one or more entities and relationships during visual exploration of source records using the source records-to-entity index.

2-6. (canceled)

7. The method of claim 1 wherein identifying and receiving a set of one or more source records of interest includes receiving a query against the entity-relationship model and, in response, updating a visual display.

8. The method of claim 7 wherein updating the visual display traverses the entity-relationship model to include a relationship that connects a new entity instance with an entity instance already visible in the entity-relationship model prior to receipt of the query.

9. The method of claim 1 wherein the entity-to-source record index entries, and the source record-to-entity index entries, are generated as data is extracted from the raw data records.

10. The method of claim 1 wherein the entity-to-source record index entries, and the source record-to-entity index entries, are internal data structures that are not exposed to a user during the visual exploration of the entity-relationship model.

11. The method of claim 1 wherein the raw data source records comprise enterprise network security-related data sources, and the entities are cybersecurity actors and assets.

12. The method of claim 1 wherein the raw data source records comprise healthcare billing-related data sources, and the entities are healthcare actors and assets.

13. The method of claim 1 wherein the raw data source records comprise financial training-related data sources, and the entities are financial-related actors and assets.

14. The method of claim 1 wherein the raw data source records comprise intelligence analysis data sources, and the entities are actors and assets.

15. The method of claim 1 wherein the raw data source records comprise counter-party risk analysis data sources, and the entities are risk-related actors and assets.

16. Apparatus for data analysis of an entity-relationship model comprising one or more entity instances, and one or more relationships between those entity instances, the entity-relationship model generated from raw data source records, comprising:
one or more computing machines;
a network-accessible display interface executing on one of the computing machines;
a source records data store to receive and store raw data source records extracted from one or more data sources;
the source records data store further storing, as an entity-to-source record index co-located with the source records, entity-to-source record index entries that relate entity instances with the source records that contribute to those entity instances;
an entity-relationship data store to receive and store the entity-relationship data model generated from the raw data source records, the entity-relationship data store being distinct from the source records data store;
the entity-relationship data store further storing, as a source record-to-entity index co-located with the entity instances to which the source records contribute, source record-to-entity index entries that relate source records to the entity instances to which the source records contribute; and
the network-accessible display interface using the entity-to-source record index to display a set of one or more source records of interest during a visual exploration of the entity-relationship model, and using the source record-to-entity index to display a set of one or more entities and relationships during a visual exploration of source records.

17. The apparatus as described in claim 16 further including an analytics application to generate the entity-relationship model, wherein the network-accessible display interface and the analytics application operate via a software-as-a-service model.

18. The apparatus as described in claim 17 wherein the analytics application receives a query and, in response, generates the entity-relationship model.

19. The apparatus as described in claim 18 wherein the entity-relationship model is updated based on the visual exploration.

20. (canceled)

21. An apparatus, comprising:
one or more hardware processors;
computer memory to store computer program instructions executed by the hardware processors, the computer program instructions comprising:
a network-accessible analytics application providing a visual explorer;
a data organizing application comprising program code (i) to ingest and store raw data records extracted from one or more data sources, (ii) to generate from the received raw data records at least one entity-relationship model, the entity-relationship model comprising one or more entity instances, and one or more relationships between those entity instances, (iii) to generate and store an entity-to-source record index, and a source record-to-entity index, the entity-to-source record index including entries that relate entity instances with the source records that contribute to those entity instances, the source record-to-entity index including entries that relate source records to the entity instances to which the source records contribute, the entity-to-source record index co-located and stored in a first data store with the raw data records, the entity-to-source record index co-located and stored in a second data store with the entity-relationship model, the first data store being distinct from the second data store, and (iv) during a visual exploration of the entity-relationship model using the visual explorer, and using the entity-to-source record index and the source record-to-entity index, to display one of: source records for an entity instance, and entity instances for a source record.

22. The apparatus of claim 21 wherein the raw data source records comprise enterprise network security-related data sources, and the entities are cybersecurity actors and assets.

23. The apparatus of claim 21 wherein the raw data source records comprise healthcare billing-related data sources, and the entities are healthcare actors and assets.

24. The apparatus of claim 21 wherein the raw data source records comprise financial training-related data sources, and the entities are financial-related actors and assets.

25. The apparatus of claim 21 wherein the raw data source records comprise intelligence analysis data sources, and the entities are actors and assets.

26. The apparatus of claim 21 wherein the raw data source records comprise counter-party risk analysis data sources, and the entities are risk-related actors and assets.

27. The method of claim 1 further including:
tracking a state of at least one entity instance over time, wherein the state comprises a collection of elements, the elements being one of: scalar features, aggregate features, and relationships to other entity instances; and
using the entity-to-source record index to find at least one source record directly contributing to a state of the at least one entity instance at a given time.
